(19) United States
(12) Patent Application Publication
(10) Pub. No.: US 2017/0103406 A1
(43) Pub. Date: Apr. 13, 2017

(54) SYSTEMS, DEVICES, AND METHODS FOR GENERATING AND RENDERING PROCUREMENT AID DATA VIA AN ELECTRONIC DISPLAY DEVICE

(71) Applicant: Wal-Mart Stores, Inc., Bentonville, AR (US)

(72) Inventor: Madhur Sarin, Bangalore (IN)

(21) Appl. No.: 14/958,859

(22) Filed: Dec. 3, 2015

(30) Foreign Application Priority Data
Oct. 12, 2015 (IN) 3271/DEL/2015

(51) Int. Cl. G06Q 30/02; G06F 3/0484; G06Q 30/00

(52) U.S. Cl. CPC G06Q 30/0204; G06Q 30/01; G06F 3/0484

(57) ABSTRACT

Methodologies, systems, and computer-readable media are provided for generating procurement aid recommendations and controlling a graphical user interface (GUI) of an electronic display device to render the a aid recommendations in response to a computational analysis of consumer activity data and estimated consumer procurement times. A procurement aid recommendation tool can receive store identification information via the GUI. A desired service level corresponding to a specific store can also be received. An estimated procurement time corresponding to consumers within the specific store can be computed, based in part on consumer activity data collected at the store. A minimal number of procurement aids required to meet the desired service level is computed, based in part on the estimated procurement time of the consumers. The GUI is configured to generate a graphical indication of the minimal number of procurement aids required to meet the desired service level at the specific store.

### RELATED APPLICATIONS

This application claims benefit of and priority to Indian Patent Application No, 3271/DEL/2015, filed Oct. 12, 2015, which is incorporated herein by reference in its entirety.

### BACKGROUND OF THE TECHNOLOGY

In general, shopping carts are used by customers within retail stores. Certain existing techniques allow store managers to estimate a number of shopping carts needed for a particular store.

### SUMMARY

Exemplary embodiments of the present disclosure provide systems, devices, and methods for generating shopping aid recommendations and for configuring a graphical user interface to generate shopping aid recommendations.

In accordance with some examples of the present disclosure, a method of controlling a graphical user interface of an electronic display device in response to a computational analysis of consumer activity data and estimated procurement times is disclosed. The method includes controlling an electronic display device to render a graphical user interface, the graphical user interface configured to receive store identification information identifying a specific store. The method also includes receiving, in an electronic computer-readable format, a value stored in a database representative of a desired service level corresponding to an expected availability of temporary procurement aids for use in the specific store. Databases can be updated with newer values, for example, through a user interface. The method further includes receiving, in an electronic computer-readable format, consumer activity data corresponding to a number of items procured by a consumer within the specific store. The method further includes computing, based on a computational analysis of the consumer activity data, an estimated procurement time corresponding to each of the consumers. The method also includes computing, based on a computational analysis of the estimated procurement time corresponding to each of the consumers, a minimal number of temporary procurement aids required to meet the desired service level. The method also includes controlling the graphical user interface of the electronic display device to render a graphical indication of the minimal number of temporary procurement aids.

In some examples, the temporary procurement aid includes a shopping cart, a shopping basket, or a handheld scanning device. In some examples, the electronic display device is further configured to dynamically update the minimal number of temporary procurement aids in response to receiving an updated desired service level via the graphical user interface. In some examples, the estimated procurement time is further computed based on the season or the time of day. In some examples, the estimated procurement time corresponding to each of the consumers is further computed based on a procurement aid retrieval rate or a procurement aid retrieval method. In some examples, the desired service level corresponds to a desired consumer satisfaction rating. In some examples, the desired service level corresponds to an expected availability of temporary procurement aids for use in the specific store during yearly peak shopping times. In some examples, the minimal number of temporary procurement aids is further computed based on historical data corresponding to a number of temporary procurement aids present at one or more stores having a substantially similar transaction volume as the specific store.

Any combination or permutation of the above examples is envisioned. It should be appreciated that all combinations of the foregoing concepts and additional concepts described in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present disclosure will be more fully understood from the following description of exemplary embodiments when read together with the accompanying drawings, in which:

FIG. 1 is a flowchart illustrating an exemplary method of controlling a graphical user interface of an electronic display device, according to embodiments of the present disclosure.

FIG. 2 is a flowchart. Illustrating another exemplary method of controlling a graphical user interface of an electronic display device, according to embodiments of the present disclosure.

FIG. 3 is a flowchart illustrating another exemplary method of controlling a graphical user interface of an electronic display device, according to embodiments of the present disclosure.

FIG. 4 depicts an exemplary graphical user interface for displaying procurement aid recommendations, according to embodiments of the present disclosure.

FIG. 5 is a diagram of an exemplary network environment suitable for a distributed implementation of exemplary embodiments of the present disclosure.

FIG. 6 is a block diagram of an exemplary computing device that can be used to perform exemplary processes in accordance with exemplary embodiments of the present disclosure.

### DETAILED DESCRIPTION

Following below are more detailed descriptions of various concepts related to, and embodiments of, inventive methods, apparatus, and systems for configuring a graphical user interface of an electronic display device to facilitate generating and displaying temporary procurement aid recommendations. It should be appreciated that various concepts introduced above and described in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

Example methodologies, systems, apparatus, and non-transitory computer-readable media are described herein for generating temporary procurement aid recommendations and configuring a graphical user interface (GUI) of an electronic display device to facilitate displaying the temporary procurement aid recommendations.

In one example, a shopping aid or procurement aid recommendation tool estimates a minimal number of temporary shopping aids or procurement aids that a store needs in order to meet a given service level. In different example implementations, the temporary procurement aid can be a shopping cart, shopping basket, handheld scanning device, or any other product temporarily used by a customer while shopping within an enterprise, or any combination of these shopping aids.

The service level corresponds to an expected availability of temporary shopping aids for use in the store. As a non-limiting example, a service level of 80% means that at least 80% of the time, a temporary shopping aid is available for retrieval by each customer or consumer upon entering the store without needing to wait. The minimal number of shopping aids, or shopping aid recommendation, for meeting a given service level is computed at least in part based on the estimated shopping times of customers. In one example, a given day can be divided into twenty four one-hour increments, and an expected number of shoppers who are present in the store can be computed for each one-hour increment based on the estimated shopping times of the customers and their arrival rate based on number of transactions recorded on the checkout counter. The estimated shopping times of the customers can be computed, at least in part, based on customer transaction data collected at the store. In one example, an estimated number of shoppers can be computed for each one-hour increment over the course of an entire week, resulting in 168 time intervals. Based on these intervals, a minimum number of temporary shopping aids can be computed such that for 80% of the 168 time intervals during the week, an individual entering the store will not need to wait before retrieving a temporary shopping aid. In such an example, during 20% of the time intervals some individuals may need to wait before being able to retrieve a shopping aid. In alternative embodiments, the time intervals may be analyzed on a bi-weekly basis, monthly basis, or over the course of some other time span.

In some example embodiments, the busiest holiday shopping week of the year can be used to calculate the shopping aid recommendation. In such an example, if a store has enough temporary shopping aids to meet an 80% service level during the busier shopping weeks of the year, there will not be a significant shortage or surplus of shopping aids during the remainder of the year.

Customer transaction data can be collected and analyzed to determine customer traffic density, customer basket size, customer shopping time, etc. In example implementations, if a customer purchases four items or less, the system may determine that the customer most likely did not use a shopping cart or temporary shopping aid. However, a larger basket size may indicate that the customer most likely used a shopping aid, and an estimation of the customer's shopping time can be computed. The estimated shopping time can be computed, at least in part, based on historical shopping data collected at the store. The shopping aid recommendation tool can establish a relationship between transactions/sales and the minimal number of shopping aids needed to meet a desired service level. Therefore, if a change in sales is expected, or if a change in shopping pattern is expected, the shopping aid recommendation tool can be used to predict an optimal number of shopping aids corresponding to the upcoming sales forecast or shopping pattern forecast. In other example implementations, the shopping cart recommendation tool can be configured to take into account the shopping cart retrieval rate and method of retrieval. Shopping aid retrieval data may include, for example, data indicative of the time required to return a shopping aid to the store entrance after checkout, or the method by which shopping aids are returned to the store entrance for further use.

The shopping aid recommendation tool can be displayed to a user via a GUI, rendered on an electronic display device. The GUI can be configured to receive store identification information, customer activity data, as well as an indication of a desired service level. Once a shopping aid recommendation corresponding to a specific store has been computed, the GUI can render a graphical indication of the shopping aid recommendation. In example implementations, the GUI can be configured to render a list or table of various shopping aid recommendations based on different service levels.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

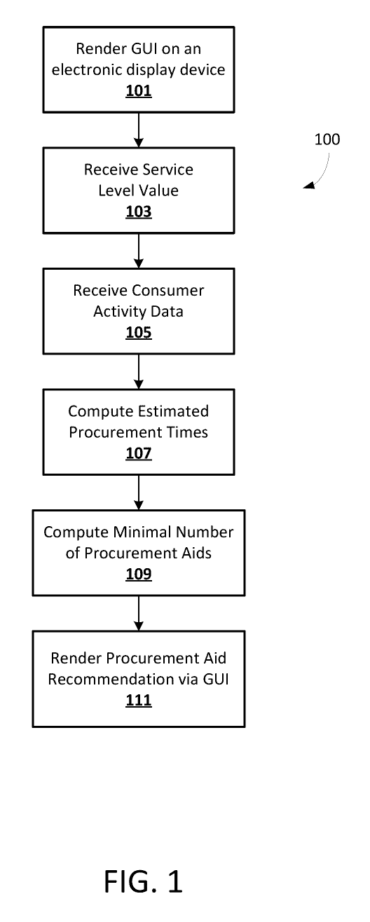

FIG. 1 is a flowchart illustrating an example method 100 for configuring a graphical user interface of an electronic display device, according to embodiments of the present disclosure. In step 101, a graphical user interface (GUI) is rendered on an electronic display device. The GUI is configured to render graphical representations of a temporary procurement aid recommendation, and to receive, among other things, store identification information identifying a specific store. The store identification information can identify a selected store from a plurality of stores, and may include, for example, and enterprise-assigned store number. This information identifies the specific store for which a temporary shopping aid recommendation is being computed. In some examples, the temporary shopping aid includes a shopping cart, shopping basket, handheld scanning device, or any other product temporarily used by a customer while shopping within an enterprise.

In step 103, a server receives a value stored in a database representative of a desired service level, in an electronic computer-readable format, associated with the specific store. The desired service level corresponds to an expected availability of temporary procurement or shopping aids for use in the store. As a non-limiting example, a service level of 75% means that at least 75% of the time, a temporary shopping aid is available for retrieval by each customer upon entering the store without needing to wait. In some examples, the desired service level corresponds to a desired customer satisfaction rating. In other examples, the desired service level can correspond to an expected availability of temporary shopping aids during yearly peak shopping times or holidays.

In step 105, a server receives customer activity data, in an electronic computer-readable format, corresponding to a number of items purchased by a customer within the specific store. This customer activity data includes, for example, data indicative of the size of the customer's shopping cart and/or the amount of time the customer spent within the store, and can be used to compute estimated shopping times in step 107 corresponding to each customer. The estimated shopping times can be computed, for example, based on the number or type of items a customer is purchasing. In one such example, customer activity data may indicate that a customer purchasing thirty items or more, for example, spends an average of about forty minutes within the store. However, customer activity data may indicate that a customer purchasing between four to ten items, or purchasing a specific type of item, spends an average of about twenty five minutes within the store. It will be appreciated that data indicative of other types or numbers of items may result in similar or different estimated shopping times than those explicitly described herein are also within the scope of the present disclosure. In some examples, the estimated shopping time can be computed based on the season or time of day when the customer is shopping. For example, during holidays or peak shopping hours, additional carts may be required because a customer may require additional time to shop for the same amount of items due to increased customer traffic.

In step 109, a minimal number of temporary shopping aids required to meet the desired service level is computed. The minimal number of shopping aids, or the temporary shopping aid recommendation, can be computed based on an analysis of the estimated shopping times computed in step 107. For example, based on the checkout times of each customer as well as the estimated shopping times of those customers, one can compute an estimated number of customers who are shopping within the store at any particular time of day. Thus, in order to meet a desired service level of 80%, for example, at least 80% of the time, a temporary shopping aid is available for retrieval by each customer upon entering the store. In one particular example, an estimated number of customers shopping within the store during each one-hour increment within a week can be computed.

In step 111, a graphical indication of the minimal number of temporary shopping aids recommended to meet the desired service level is rendered via the GUI. As described above, the GUI may also display additional information regarding the selected sore. For example, the GUI can be configured to display a comparison of the new shopping aid recommendation against a previous recommendation or the against the current number of shopping aids. The GUI may also display various graphs or charts comparing shopping aid recommendations based on service level.

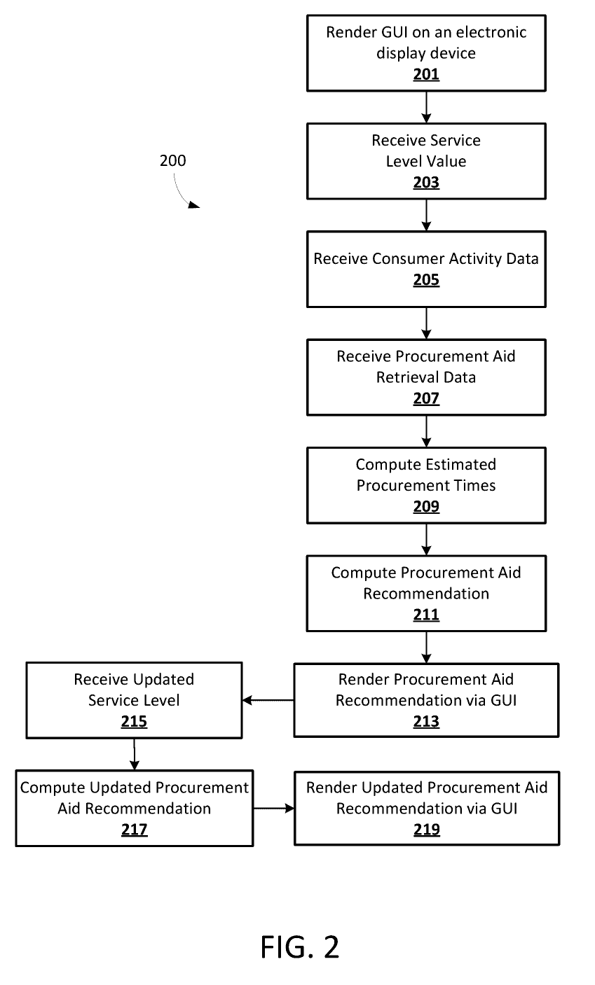

FIG. 2 is a flowchart illustrating another example method 200 for configuring graphical user interface of an electronic display device, according to embodiments of the present disclosure. In step 201, a GUI is rendered on an electronic display device. The GUI is configured to render graphical representations of a temporary shopping aid recommendation, and to receive, among other things, store identification information identifying a specific store. The store identification information can identify a selected store from a plurality of stores, and may include, for example, and enterprise-assigned store number. This information identifies the specific store for which a temporary shopping aid recommendation is being computed. In some examples, the temporary shopping aid includes a shopping cart, shopping basket, handheld scanning device, or any other product temporarily used by a customer while shopping within an enterprise.

In step 203, a server receives a value stored in a database representative of a desired service level, in an electronic computer-readable format, associated with the specific store. The desired service level corresponds to an expected availability of temporary shopping aids for use in the store. For example, a service level of 75% signifies that 75% of the time, a temporary shopping aid, such as a shopping cart or portable scanning device, is available for retrieval by each customer upon entering the store. In some examples, the desired service level corresponds to a desired customer satisfaction rating. In other examples, the desired service level can correspond to an expected availability of temporary shopping aids during yearly peak shopping times or holidays.

In step 205, a server receives customer activity data, in an electronic computer-readable format, corresponding to a number of items purchased by a customer within the specific store. This customer activity data includes, for example, data indicative of the size of the customer's shopping cart and/or the amount of time the customer spent within the store. In step 207, a server receives shopping aid retrieval data, in an electronic computer-readable format. The shopping aid retrieval data may include, for example, data indicative of the time required to return a shopping aid to the store entrance after checkout, or the method by which shopping aids are returned to the store entrance for further use. For example, some stores may rely on customers to return shopping aids to a designated area after use, or a store may assign its workers to collect and retrieve shopping aids after customers have finished using them. In some examples, workers may have retrieval tools such as motorized cart pushing machines to aid them in rapid shopping cart retrieval.

In step 209, an estimated shopping time corresponding to each customer is computed based on the customer activity data. The estimated shopping times can be computed, for example, based on the number or type of items a customer is purchasing. In one such example, customer activity data may indicate that a customer purchasing thirty items or more, for example, spends an average of about forty minutes within the store. However, customer activity data may indicate that a customer purchasing between four to ten items, or purchasing a specific type of item, spends an average of about twenty five minutes within the store. It will be appreciated that data indicative of other types or numbers of items may result in similar or different estimated shopping times than those explicitly described herein are also within the scope of the present disclosure. In some examples, the estimated shopping time is also computed based on the season or time of day when the customer is shopping. For example, during holidays or peak shopping hours, additional carts may be required because a customer may require additional time to shop for the same amount of items due to increased customer traffic.

In step 211, a shopping aid recommendation is computed. The temporary shopping aid recommendation, can be computed based on an analysis of the estimated shopping times computed in step 209, the shopping aid retrieval data, as well as the desired service level. For example, based on the checkout times of each customer as well as the estimated shopping times of those customers, one can compute an estimated number of customers who are shopping within the store at any particular time of day. Thus, in order to meet a desired service level of 80%, for example, at least 80% of the time a temporary shopping aid is available for retrieval by each customer upon entering the store. In one particular example, an estimated number of customers shopping within the store during each one-hour increment within a week can be computed. In some examples, the shopping aid recommendation may also take into account shopping aid retrieval data. Based on the shopping aid retrieval data, the shopping aid recommendation value may be increased in order to account for the time required to return temporary shopping aids to the front of a store after customers have completed checkout.

In step 213, a GUI is configured to render a graphical indication of the shopping aid recommendation. As described above, the GUI may also be configured to display additional information regarding the selected sore. For example, the GUI can display a comparison of the new shopping aid recommendation against a previous recommendation or the against the current number of shopping aids. The GUI may also display various graphs or charts comparing shopping aid recommendations based on service level.

In step 215, a server receives a value stored in a database representative of an updated desired service level, in an electronic computer-readable format. Once the updated desired service level is received in step 215, an updated shopping aid recommendation is computed in step 217. The updated shopping aid recommendation can be computed, for example, as described above in reference to step 211. Once computed, a graphical indication of the updated shopping aid recommendation is rendered in step 219. The functionality disclosed in steps 215, 217, and 219 allows a user to dynamically update the shopping aid recommendation in response to an updated service level. In some examples, the updated service level can be input by the user via the GUI.

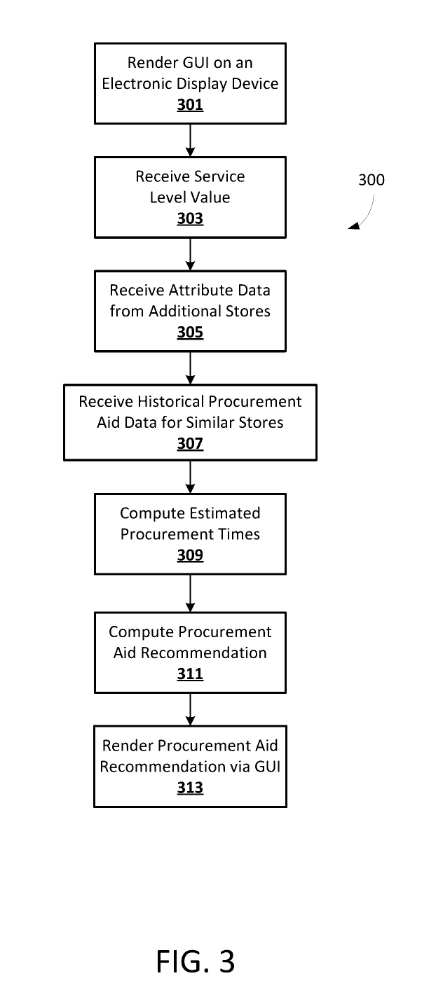

FIG. 3 is a flowchart illustrating another example method 300 for configuring a graphical user interface of an electronic display device, according to embodiments of the present disclosure. In step 301, a graphical user interface (GUI) is rendered on an electronic display device. The GUI is configured to render graphical representations of a temporary shopping aid recommendation corresponding to a specific store. In some examples, the specific store may be a prospective store that is not yet completed or not yet open for business. In such a scenario, because there is not yet any customer traffic corresponding to the store, a shopping aid recommendation may be calculated by calculating the shopping aid recommendation corresponding to an existing store that has a transaction volume, or other store characteristics, similar to the expectations of the prospective store. As described above, the temporary shopping aid can include a shopping cart, shopping basket, handheld scanning device, or any other product temporarily used by a customer while shopping within an enterprise.

In step 303, a server receives a value stored in a database representative of a desired service level, in an electronic computer-readable format, associated with the specific store. The desired service level corresponds to an expected availability of temporary shopping aids for use in the store. For example, a service level of 75% signifies that 75% of the time, a temporary shopping aid, such as a shopping cart or portable scanning device, is available for retrieval by a customer upon entering the store. In some examples, the desired service level corresponds to a desired customer satisfaction rating. In other examples, the desired service level can correspond to an expected availability of temporary shopping aids during yearly peak shopping times or holidays.

In step 305, a server associated with the enterprise receives attribute data corresponding to additional stores within the enterprise. This store attribute data can be used to determine which existing stores have characteristics similar to a prospective store. In some examples, the store attribute data may include geographical data, store square-footage, transaction volume, parking lot area, local population density, operating hours, store type, local demographic data, etc.

In step 30′7, a server associated with the enterprise receives historical shopping aid data corresponding to stores having similar characteristics to the prospective store. As described above, because there is no historical customer activity data relating to prospective stores, a shopping aid recommendation may be calculated, based at least in part on the shopping aid recommendations corresponding to existing stores that have a similar transaction volume, or other characteristics similar to those expected from the prospective store.

In step 309, an estimated shopping time corresponding to customers from the similar stores is computed based on the customer activity data. The estimated shopping times can be computed, for example, as described above in reference to steps 107 and/or 209. These estimated shopping times can then be used to compute a shopping aid recommendation in step 311. The shopping aid recommendation for a prospective store can be computed based on an analysis of the estimated shopping times computed in step 309 corresponding to similar stores. For example, based on the checkout times of customers within one or more similar stores, as well as the estimated shopping times of those customers, one can compute an estimated number of customers who are expected to be shopping within the prospective store at any particular time of day. In order to meet a desired service level of 80%, for example, at least 80% of the time a temporary shopping aid must be available for retrieval by each customer upon entering the store. In one particular example, an analysis of the similar stores may indicate, for example, that 112 carts is the minimum number of aids needed to meet a service level of 80%. Thus, in order to meet the desired service level of 80%, the prospective store should have at least 112 shopping aids.

In step 313, a graphical indication of the shopping aid recommendation for the prospective store is rendered via the GUI. As described above, the GUI may also display additional information regarding the selected sore. For example, the GUI can display a comparison of the new shopping aid recommendation against a previous recommendation or the against the current number of shopping aids. The GUI may also display various graphs or charts comparing shopping aid recommendations based on service level.

In any example implementation herein, the shopping aid recommendation may be computed using queuing theory (which is based on the computational analysis of waiting lines, also referred to as queues). In an example computation using queuing theory, data such as but not limited to one or more of customer arrival rate, customer shopping trip time, queue length, and waiting time for retrieving a shopping aid by a customer, can be used to compute a shopping aid recommendation.

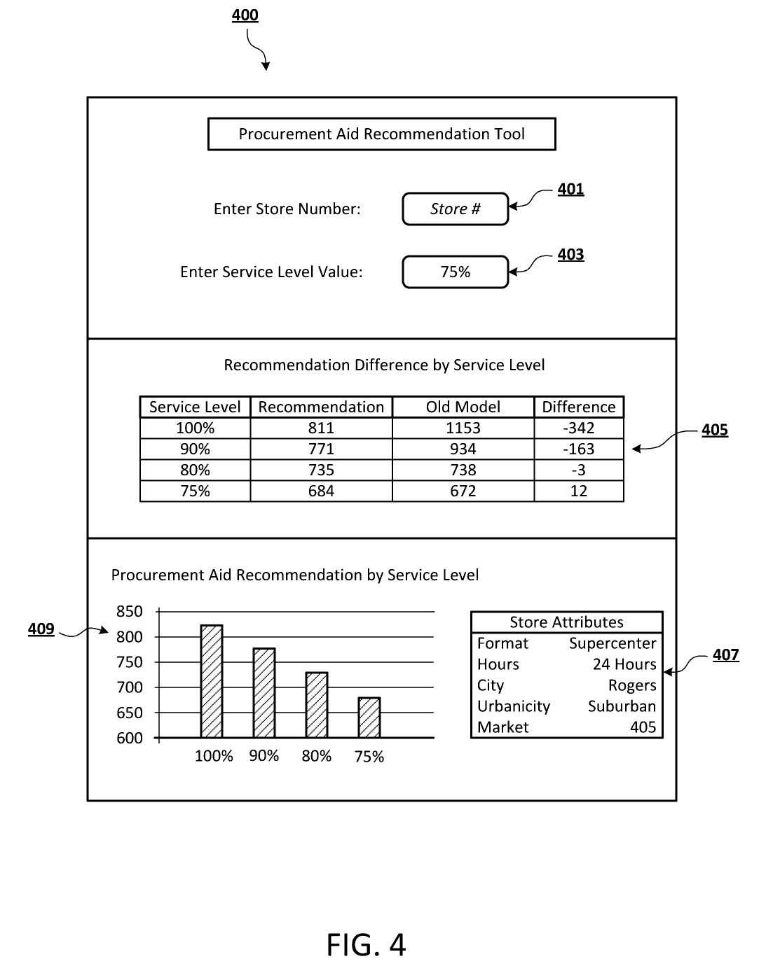

FIG. 4 depicts an exemplary graphical user interface 400 for rendering a shopping aid recommendation tool, according to embodiments of the present disclosure. As shown in this particular example, the GUI can provide a field 401 that allows a user to enter a store number, other identifying information, in order to identify a specific store for which a shopping aid recommendation is being computed. Additionally, the GUI can be configured to provide a second field 403 that allows a user to enter data indicative of a desired service level. This data is used to compute the shopping aid recommendation, as described above in some examples, the GUI can be configured to display a table or listing 405 that shows the recommendation difference, compared to a previous model, corresponding to various service levels. In an example implementation, a shopping aid recommendation of 811 corresponds to a service level of 100%, which is a decrease of 342 shopping aids over the previous model of 1153 present in the store. Similarly, a shopping aid recommendation of 771 corresponds to a service level of 90%, which is a decrease of 163 shopping aids over the previous model of 934; a shopping aid recommendation of 735 corresponds to a service level of 80%, which is a decrease of 3 shopping aids over the previous model of 735; and a shopping aid recommendation of 684 corresponds to a service level of 75%, which is an increase of 12 shopping aids over the previous model of 672. It will be appreciated that other service levels, customer activity data, store attribute data, etc. may result in similar or different shopping aid recommendations than those explicitly described herein are also within the scope of the present disclosure.

The GUI can also include, for example, a listing of various store attributes 407 corresponding to the selected store. Store attributes can include, for example, store format, operating hours, city name, regional population density or urbanicity, store market, etc. In this particular example, the GUI also includes a graph 409 showing a visual representation of the shopping aid recommendation values by service level. In other examples, the GUI can include additional graphs or charts displaying data related to service levels, shopping aid recommendations, store attributes, similar stores, etc.

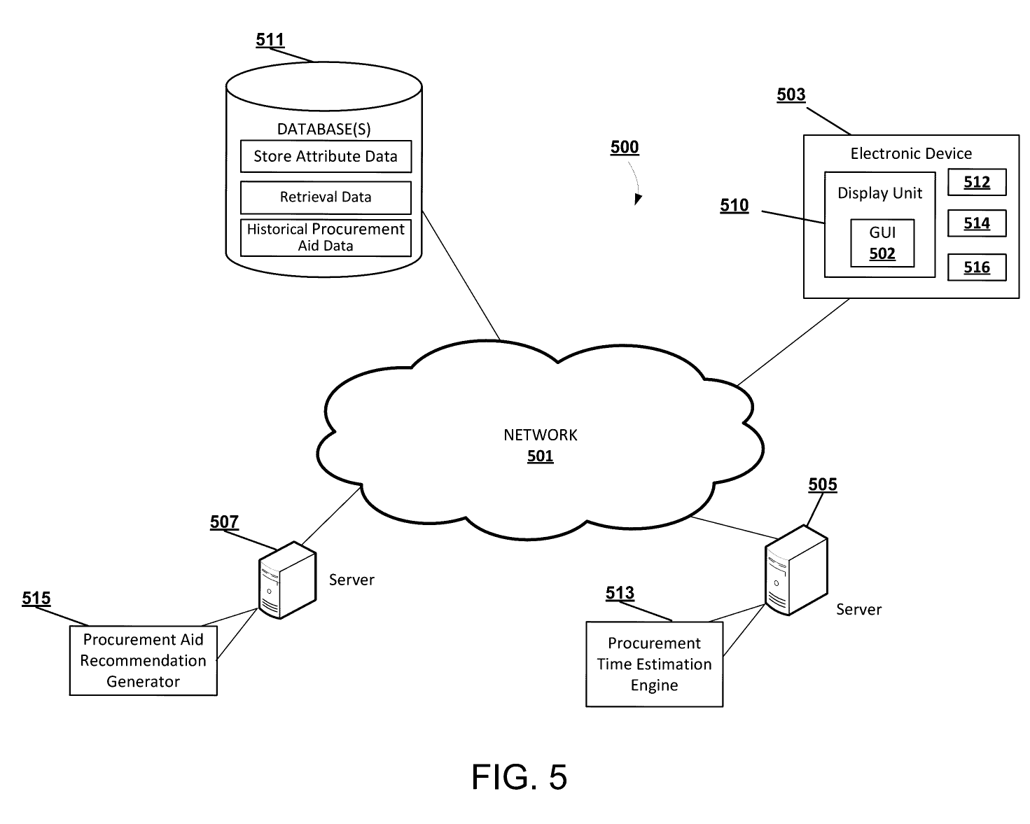

FIG. 5 is a diagram of an example network environment 500 suitable for a distributed implementation of example embodiments. The network environment 500 can include one or more servers 505 and 507, and a database 511, associated with servers 505 and 507. In exemplary embodiments, the database 511 can store the various store attribute data, procurement aid retrieval data, historical procurement aid data, etc., while the servers 505 and 507 can store procurement or shopping time estimation engine 513 and procurement or shopping aid recommendation generator 515, which can implement one or more of the processes described herein with respect to FIGS. 1-3. The network environment may also include an electronic display device 503, that may display a GUI 502 to a user. The electronic display device 503 can include a display unit 510; a processing device 512; memory 514; and a network interface 516 where the processing device executes instructions in memory (e.g., in response to instructions from the servers 505 or 507) to control an operation of the display unit as described herein. Once the electronic device 503 receives instructions transmitted by the servers 505 or 507 (e.g., via the network interface 516), the GUI 502 may be rendered on the display unit 510 of the electronic device 503 (e.g., in response to execution of the instructions by the processing device 512) to allow a user of the electronic device 503 to interact with the server 505 or 507 to implement embodiments of the present disclosure.

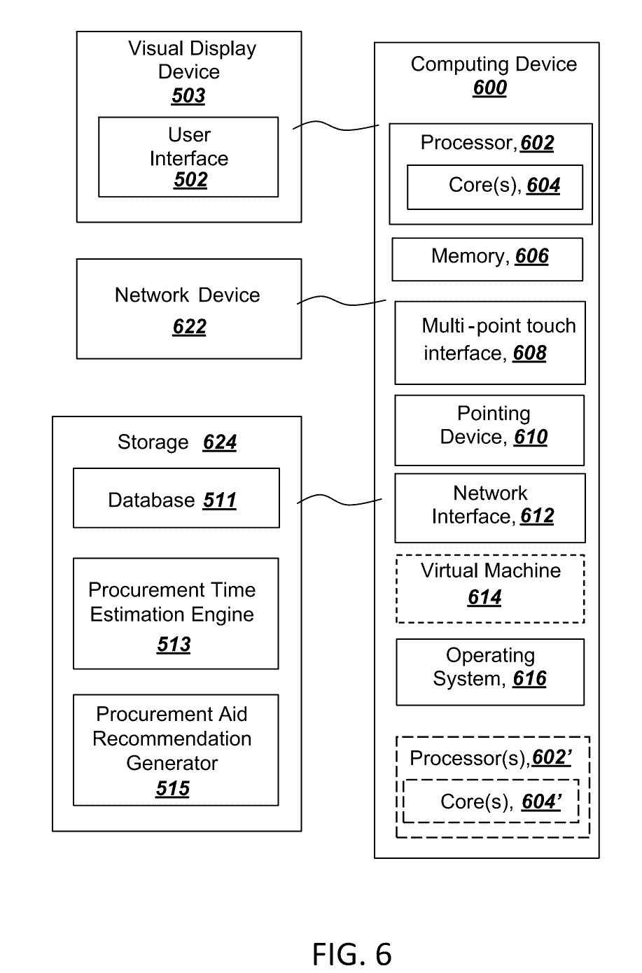

In exemplary embodiments, the servers 505 and 507, database 511, and the electronic device 503 may be in communication with each other via a communication network 501. The communication network 501 may include, but is not limited to, the Internet, an intranet, a LAN (Local Area Network), a WAN (Wide Area Network), a MAN (Metropolitan Area Network), a wireless network, an optical network, and the like. In exemplary embodiments, the electronic device 503 that is in communication with the servers 505 and 507, and database 511 can generate and transmit a database query requesting information from the raw data matrices or database 511. As described above in reference to FIGS. 1-3, the servers 505 and 507 can transmit instructions to the electronic device 503 over the communication network 501. The servers 505 and 507 can interact with the electronic device 503 and database 511 over communication network 501 to render a GUI on an operation of the electronic device 503, as described herein. Each of the servers 505 and 507, shopping time estimation engine 513, shopping aid recommendation generator 515, and electronic device 503, can be implemented using one or more components described in reference to computing device 600 and visual display device 503, which are described in more detail below with respect to FIG. 6.

FIG. 6 is a block diagram of an exemplary computing device 600 that can be used in the performance of any of the example methods according to the principles described herein. The computing device 600 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like. For example, memory 606 included in the computing device 600 can store computer-readable and computer-executable instructions or software for implementing exemplary embodiments, such as a procurement time estimation engine 513 and/or a procurement aid recommendation generator 515 associated with embodiments of the shopping aid recommendation tool and programmed to perform processes described herein. The computing device 600 also includes processor 602 and associated core 604, and optionally, one or more additional processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ can each be a single core processor or multiple core (604 and 604′) processor.

Virtualization can be employed in the computing device 600 so that infrastructure and resources in the computing device can be shared dynamically. A virtual machine 614 can be provided to handle a process running on multiple processors so that the process appears to be using only one computing resource rather than multiple computing resources. Multiple virtual machines can also be used with one processor.

Memory 606 can be non-transitory computer-readable media including a computer system memory or random access memory, such as DRAM, SRAM, EDO RAM, and the like. Memory 606 can include other types of memory as well, or combinations thereof.

A user can interact with the computing device 600 through a visual display device 503, such as a touch screen display or computer monitor, which can display one or more user interfaces 502 that can be provided in accordance with exemplary embodiments, for example, the exemplary user interface illustrated in FIG. 4. The computing device 600 can include other I/O devices for receiving input from a user, for example, a keyboard or any suitable multi-point touch interface 608, a pointing device 610 (e.g., a pen, stylus, mouse, or trackpad). The keyboard 608 and the pointing device 610 can be coupled to the visual display device 503. The computing device 600 can include other suitable conventional I/O peripherals.

The computing device 600 can also include one or more storage devices 624, such as a hard-drive, CD-ROM, or other non-transitory computer readable media, for storing data and computer-readable instructions and/or software, such as the shopping time estimation engine 513 and shopping aid recommendation generator 515, which may implement exemplary embodiments of the methods and systems as taught herein, or portions thereof. Exemplary storage device 624 can also store one or more databases 511 for storing any suitable information required to implement exemplary embodiments. The databases can be updated by a user or automatically at any suitable time to add, delete or update one or more items in the databases. Exemplary storage device 624 can store one or more databases 511 for storing store attribute data, shopping aid retrieval data, historical shopping aid data, and any other data/information used to implement exemplary embodiments of the systems and methods described herein.

The computing device 600 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 612 can include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 600 can run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 616 can be run in native mode or emulated mode. In an exemplary embodiment, the operating system 616 can be run on one or more cloud machine instances

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A method for controlling a graphical user interface of an electronic display device in response to a computational analysis of consumer activity data and estimated procurement times, the method comprising:
controlling an electronic display device to render a graphical user interface, the graphical user interface configured to receive store identification information identifying a specific store;
receiving, in an electronic computer-readable format, a value stored in a database representative of a desired service level corresponding to an expected availability of temporary procurement aids for use in the specific store;
receiving, in an electronic computer-readable format, consumer activity data corresponding to a number of items procured by a consumer within the specific store;
computing, based on a computational analysis of the consumer activity data, an estimated procurement time corresponding to each of the consumers;
computing, based on a computational analysis of the estimated procurement time corresponding to each of the consumers, a minimal number of temporary procurement aids required to meet the desired service level; and
controlling the graphical user interface of the electronic display device to render a graphical indication of the minimal number of temporary procurement aids.

2. The method of claim 1, wherein the temporary procurement aid comprises a shopping cart, a shopping basket, or a handheld scanning device.

3. The method of claim 1, further comprising dynamically updating the minimal number of temporary procurement aids in response to receiving an updated desired service level via the graphical user interface.

4. The method of claim 1, wherein the estimated procurement time is further computed based on the season or the time of day.

5. The method of claim 1, wherein the estimated procurement time corresponding to each of the consumers is further computed based on a procurement aid retrieval rate or a procurement aid retrieval method.

6. The method of claim 1, wherein the desired service level corresponds to a desired consumer satisfaction rating.

7. The method of claim 1, wherein the desired service level corresponds to an expected availability of temporary procurement aids for use in the specific store during yearly peak shopping times.

8. The method of claim 1, the minimal number of temporary procurement aids being further computed based on historical data corresponding to a number of temporary procurement aids present at one or more stores having a substantially similar transaction volume as the specific store.

9. A system of controlling a graphical user interface of an electronic display device in response to a computational analysis of consumer activity data and estimated procurement times, the system comprising:
one or more servers programmed to:
receive, in an electronic computer-readable format, consumer activity data corresponding to a number of items procured by a consumer within a specific store;
receive, in an electronic computer-readable format, a value stored in a database representative of a desired service level corresponding to an expected availability of temporary procurement aids for use in the specific store;
compute an estimated procurement time corresponding to each of the consumers based on a computational analysis of the consumer activity data; and
compute a minimal number of temporary procurement aids required to meet the desired service level based on a computational analysis of the estimated procurement time corresponding to each of the consumers; and
an electronic display device programmed to:
render a graphical user interface, the graphical user interface configured to receive store identification information identifying the specific store; and
control the graphical user interface to render a graphical indication of the minimal number of temporary procurement aids.

10. The system of claim 9, wherein the temporary procurement aid comprises a shopping cart, a shopping basket, or a handheld scanning device.

11. The system of claim 9, wherein the electronic display device is further configured to dynamically update the minimal number of temporary procurement aids in response to receiving an updated desired service level via the graphical user interface.

12. The system of claim 9, wherein the estimated procurement time is further computed based on the season or the time of day.

13. The system of claim 9, wherein the estimated procurement time corresponding to each of the consumers is further computed based on a procurement aid retrieval rate or a procurement aid retrieval method.

14. The system of claim 9, wherein the desired service level corresponds to a desired consumer satisfaction rating.

15. The system of claim 9, wherein the desired service level corresponds to an expected availability of temporary procurement aids for use in the specific store during yearly peak shopping times.

16. The system of claim 9, the minimal number of temporary procurement aids being further computed based on historical data corresponding to a number of temporary procurement aids present at one or more stores having a substantially similar transaction volume as the specific store.

17. A non-transitory computer readable medium storing instructions executable by a processing device, wherein execution of the instructions causes the processing device to implement a method of controlling a graphical user interface of an electronic display device in response to a computational analysis of consumer activity data and estimated procurement times, the method comprising:
controlling an electronic display device to render a graphical user interface, the graphical user interface configured to receive store identification information identifying a specific store;
receiving, in an electronic computer-readable format, a value stored in a database representative of a desired service level corresponding to an expected availability of temporary procurement aids for use in the specific store;
receiving, in an electronic computer-readable format, consumer activity data corresponding to a number of items procured by consumers within the specific store;
computing, based on a computational analysis of the consumer activity data, an estimated procurement time corresponding to each of the consumers;
computing, based on a computational analysis of the estimated procurement time corresponding to each of the consumers, a minimal number of temporary procurement aids required to meet the desired service level; and
controlling the graphical user interface of the electronic display device to render a graphical indication of the minimal number of temporary procurement aids.

18. The medium of claim 17, wherein the temporary procurement aid comprises a shopping cart, a shopping basket, or a handheld scanning device.

19. The medium of claim 17, further comprising dynamically updating the minimal number of temporary procurement aids in response to receiving an updated desired service level via the graphical user interface.

20. The medium of claim 17, wherein the estimated procurement time is further computed based on the season or the time of day.

21. The medium of claim 17, wherein the estimated procurement time corresponding to each of the consumers is further computed based on a procurement aid retrieval rate or a procurement aid retrieval method.

22. The medium of claim 17, wherein the desired service level corresponds to a desired consumer satisfaction rating.

23. The medium of claim 17, wherein the desired service level corresponds to an expected availability of temporary procurement aids for use in the specific store during yearly peak shopping times.

24. The medium of claim 17, the minimal number of temporary procurement aids being further computed based on historical data corresponding to a number of temporary procurement aids present at one or more stores having a substantially similar transaction volume as the specific store.
